(19) United States
(12) Patent Application Publication
(10) Pub. No.: US 2025/0197657 A1
(43) Pub. Date: Jun. 19, 2025

(54) STRUCTURE

(71) Applicant: Murata Manufacturing Co., Ltd., Nagaokakyo-shi (JP)

(72) Inventors: Takayuki KONO, Nagaokakyo-shi (JP); Yasunori HIOKI, Nagaokakyo-shi (JP); Masanori ABE, Nagaokakyo-shi (JP)

(21) Appl. No.: 19/068,246

(22) Filed: Mar. 3, 2025

Related U.S. Application Data
(63) Continuation of application No. PCT/JP2023/029315, filed on Aug. 10, 2023.

(30) Foreign Application Priority Data
Sep. 7, 2022 (JP) 2022-142446

(51) Int. Cl. C09D 7/62; C01B 32/921; C08K 7/00; C09D 7/40; C09D 133/04; C09D 175/08

(52) U.S. Cl. CPC C09D 7/62; C01B 32/921; C09D 7/67; C09D 7/68; C09D 7/70; C09D 133/04; C09D 175/08; C01P 2004/24; C01P 2004/62; C01P 2004/64; C08K 7/00; C08K 2201/005; C08K 2201/011

(57) ABSTRACT

A structure that includes: one or more substrates having flexibility; and one or more films in contact with the one or more substrates. The one or more films contain two-dimensional particles including one or plural layers, and a polymer. The one or plural layers include a layer body represented by: MₘXₙ, wherein M is at least one metal of Groups 3-7, X is a carbon atom, a nitrogen atom, or a combination therefor, n is 1 to 4, and m is more than n and 5 or less. A modifier or terminal T exists on a surface of the layer body. A proportion of the two-dimensional particles in the one or more films is 5 to 75 vol % based on 100 vol % of a total of the two-dimensional particles and the polymer, and the two-dimensional particles have a number average particle size of 0.001 μm to 0.8 μm.

### CROSS REFERENCE TO RELATED APPLICATIONS

The present application is a continuation of International application No. PCT/JP2023/029315, filed Aug. 10, 2023, which claims priority to Japanese Patent Application No. 2022-142446, filed Sep. 7, 2022, the entire contents of each of which are incorporated herein by reference.

### TECHNICAL FIELD

The present disclosure relates to a structure.

### BACKGROUND ART

In recent years, MXene has been attracting attention as a new material having conductivity. MXene is a type of so-called two-dimensional material, and is a layered material in the form of one or plural layers as described below. In general, MXene is in the form of particles (which can include powders, flakes, nanosheets, and the like) of such a layered material.

Currently, various studies are being conducted toward the application of MXene to various electrical devices. For example, studies are being conducted for improvement in conductivity of a material containing MXene.

Patent Document 1 describes that high conductivity and high strength can be maintained by using MXene and a polymer having at least one selected from the group consisting of a fluorine atom, a chlorine atom, an oxygen atom, and a nitrogen atom as a hydrogen acceptor and a hydroxyl group and/or a secondary amino group as a hydrogen donor.

Meanwhile, Patent Document 2 describes a resin multilayer substrate including flexible resin layers, a line conductor stacked on one of the resin layers, and a grounding conductor.

Patent Document 1: WO 2022/030444 A

Patent Document 2: WO 2014/156422 A

### SUMMARY

Patent Document 1 describes, for example, that the conductive composite material has high conductivity and in a tape peeling test, cohesive fracture of a film (fracture inside a film) is less likely to occur. However, when the conductive composite material described in Patent Document 1 is applied to a substrate having flexibility as described in Patent Document 2, stress may be concentrated at an interface of the conductive composite material at the time of bending and/or stretching. Furthermore, when the proportion of the polymer in the conductive composite material is increased, stress may be more easily concentrated at the interface between the polymer and the MXene.

An object of the present disclosure is to provide a structure that includes a substrate having flexibility and includes a film containing two-dimensional particles, and in the structure, breakage of the film at the time of bending and/or stretching is suppressed.

A structure of the present disclosure includes:
one or more substrates having flexibility; and
one or more films in contact with at least a part of a surface of the one or more substrates,
the one or more films contain two-dimensional particles including one or plural layers and contain a polymer,
the one or plural layers include:
a layer body represented by:
MₘXₙ
wherein M is at least one metal of Group 3, 4, 5, 6, or 7,
X is a carbon atom, a nitrogen atom, or a combination of a carbon atom and a nitrogen atom,
n is 1 to 4, and
m is more than n and 5 or less; and
a modifier or terminal T exists on a surface of the layer body, wherein T is at least one selected from a hydroxyl group, a fluorine atom, a chlorine atom, an oxygen atom, and a hydrogen atom,
a proportion of the two-dimensional particles in the one or more films is 5 to 75 vol % based on 100 vol % of a total of the two-dimensional particles and the polymer, and
the two-dimensional particles have a number average particle size of 0.001 to 4 μm.

According to the present disclosure, a structure can be provided that includes a substrate having flexibility and includes a film containing two-dimensional particles, and in the structure, breakage of the film at the time of bending and/or stretching is suppressed.

### BRIEF DESCRIPTION OF THE DRAWINGS

FIGS. 1A and 1B are schematic sectional views showing a film, in which FIG. 1A shows a conventional film containing two-dimensional particles and FIG. 1B shows a film in one embodiment of the present disclosure;

FIG. 2 is an enlarged sectional view of a part of a structure according to First Embodiment;

FIGS. 3A and 3B are schematic sectional views showing two-dimensional particles of a layered material according to one embodiment of the present disclosure, in which FIG. 3A shows single-layer MXene particles and FIG. 3B shows multilayer (exemplarily, two-layer) MXene particles;

FIG. 4 is an enlarged sectional view of a part of a structure according to Second Embodiment;

FIGS. 5A and 5B are scanning electron microscope images of a section of a film, in which FIG. 5A shows a film in a structure of Comparative Example 1 and FIG. 5B shows a film in a structure of Example 1;

FIGS. 6A and 6B are explanatory views showing a method of a bending test, in which FIG. 6A is an explanatory view showing a method of a bending test in Examples 1 to 9 and Comparative Examples 1 and 2 and FIG. 6B is an explanatory view showing a method of a bending test in Example 10; and

FIGS. 7A and 7B are explanatory views showing a result of a bending test.

### DETAILED DESCRIPTION

A structure of the present disclosure includes:
one or more substrates having flexibility; and
one or more films in contact with at least a part of a surface of the one or more substrates,
the one or more films contain two-dimensional particles including one or plural layers and contain a polymer,
the one or plural layers include:
a layer body represented by:
MₘXₙ
wherein M is at least one metal of Group 3, 4, 5, 6, or 7,
X is a carbon atom, a nitrogen atom, or a combination of a carbon atom and a nitrogen atom,
n is 1 to 4, and
m is more than n and 5 or less; and
a modifier or terminal T exists on a surface of the layer body, wherein T is at least one selected from a hydroxyl group, a fluorine atom, a chlorine atom, an oxygen atom, and a hydrogen atom,
a proportion of the two-dimensional particles in the one or more films is 5 to 75 vol % based on 100 vol % of a total of the two-dimensional particles and the polymer, and the two-dimensional particles have a number average particle size of 0.001 to 4 μm.

The structure of the present disclosure includes a substrate having flexibility and includes a film containing two-dimensional particles, and in the structure, breakage of the film at the time of bending and/or stretching can be suppressed.

Although the present disclosure is not bound by any theory, in the structure of the present disclosure, the following is considered as the reason why breakage of the film at the time of bending and/or stretching can be suppressed. That is, in the film in the structure of the present disclosure, the proportion of the two-dimensional particles is 5 to 75 vol % based on the total of the two-dimensional particles and the polymer, and the two-dimensional particles have a number average particle size in the range of 0.001 to 4 μm, and thus the two-dimensional particles are considered to have good dispersibility in the film. Therefore, it is considered that even if a stress is applied to the structure of the present disclosure, concentration of the stress on a specific portion can be suppressed in the film and thus a structure can be obtained that is excellent in bending resistance and/or stretch resistance.

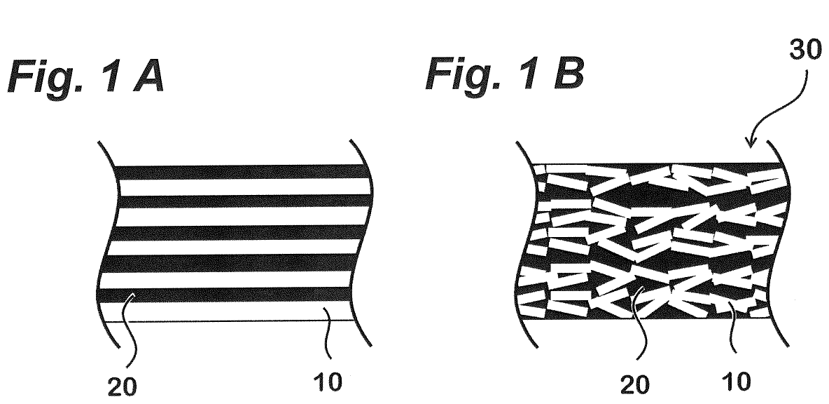

For example, specifically, a case as an example will be described in which a film contains two-dimensional particles and a polymer. As shown in FIG. 1B, in the case of two-dimensional particles 10 having a small particle size, a film 30 contains the two-dimensional particles 10 dispersed in a polymer 20, and the interfacial area per unit volume between the two-dimensional particles 10 and the polymer 20 is considered to be large. Therefore, it is considered that when a stress is applied to the film 30, the stress is dispersed and less likely to be concentrated at one portion and as a result, the film 30 is less likely to break. Furthermore, it is considered that the film 30 easily deforms following the stress to improve the adhesion between the film 30 and a substrate 50. Meanwhile, in a conventional film containing two-dimensional particles 10 having a large number average particle size as shown in FIG. 1A, it is considered that the two-dimensional particles 10 and a polymer 20 each exist in layers. In this case, it is considered that stress tends to concentrate at the interface between the two-dimensional particles 10 and the polymer 20, a crack generated at one portion propagates, and thus the entire film tends to break. However, a conventional film is considered to have a plurality of fracture modes, and is not limited to the above fracture aspect.

### First Embodiment

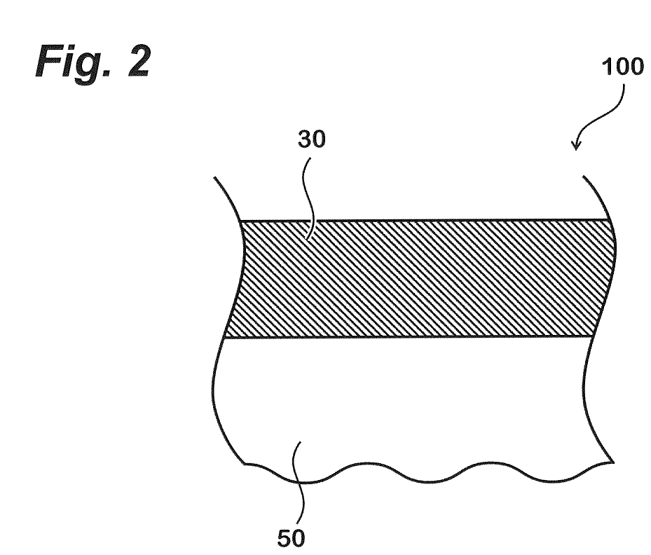

As shown in FIG. 2, a structure in the present embodiment includes a substrate 50 having flexibility and a film 30 being in contact with at least a part of a surface of the substrate 50.

In the present disclosure, the phrase “substrate having flexibility” means a substrate that can bend without breakage and can maintain the bending state.

The substrate 50 can contain at least one selected from resin layers and metal layers, and may be a single layer including one layer selected from resin layers and metal layers, or may be a laminate including two or more layers selected from resin layers and metal layers. In one aspect, the substrate 50 may be a laminate in which one or a plurality of resin layers and one or a plurality of metal layers are stacked. Alternatively, the substrate 50 may be a laminate obtained by stacking a plurality of metal foil-clad resin layers in which a resin layer is covered with a metal foil serving as a metal layer. The metal layer may be a continuous metal layer, or may be a layer including one or a plurality of conductor patterns in which a metal line extends along a planar direction. Two metal layers stacked in the thickness direction may be electrically connected to each other by an interlayer connection conductor such as a via hole conductor, and two resin layers stacked in the thickness direction may be in contact with each other with or without a metal layer interposed therebetween. In each layer that can be included in the substrate 50, a resin and a metal may exist on the same plane. A resin layer and a metal layer may be bonded to each other with an adhesive interposed therebetween, or may be bonded to each other, without an adhesive interposed therebetween, with a method such as thermocompression bonding.

Examples of the resin included in the resin layer include thermoplastic resins, and examples of the thermoplastic resins include super engineering plastics such as polyimides, fluororesins, polyether ether ketone, polyphenylene sulfide, polyether imide, and liquid crystal polymers.

The resin layer may have a thickness of, for example, 5 to 1,000 μm.

The metal included in the metal layer is preferably a conductive metal, and specific examples of the metal include gold, silver, copper, and aluminum. The metal layer can have a thickness of, for example, 5 to 1,000 μm.

The substrate 50 may have an irregular shape or a polygonal shape, and the polygonal shape may be either a convex polygonal shape or a concave polygonal shape. The substrate may have a periphery partially including a curve (a curve having a curvature of more than 0). The substrate 50 may have a linear shape or a cable shape.

The surface of the substrate 50 may be flat or may be not flat, and the substrate 50 may have a surface shape such as a curved shape, an uneven shape, or an irregular shape.

The thickness of the substrate 50 is not particularly limited, and can be, for example, 5 to 10,000 μm.

The film 30 is to be in contact with at least a part of the surface of the substrate 50. For example, the film 30 is in contact with at least one of a resin layer and/or a metal layer included in the substrate 50, and in a case where the substrate 50 includes two or more resin layers and/or metal layers, the film 30 may be in contact with all of the resin layers and/or the metal layers included in the substrate 50.

The film 30 contains two-dimensional particles and a polymer.

The two-dimensional particles include one or plural layers,
the one or plural layers include:
a layer body represented by a formula described below wherein M is at least one metal of Group 3, 4, 5, 6, or 7 and includes at least a Ti atom,
X is a carbon atom, a nitrogen atom, or a combination of a carbon atom and a nitrogen atom,
n is 1 to 4, and
m is more than n and 5 or less; and
a modifier or terminal T existing on a surface of the layer body, wherein T is at least one selected from the group consisting of a hydroxyl group, a fluorine atom, a chlorine atom, an oxygen atom, and a hydrogen atom.

The two-dimensional particles can be understood as a layered material or a layered compound and is also represented by “MₘXₙTₛ” wherein s is any number, and conventionally, x or z may be used instead of s. Typically, n can be 1, 2, 3, or 4, but is not limited thereto.

In the present disclosure, the layer may be referred to as an MXene layer, and the two-dimensional particles may be referred to as MXene two-dimensional particles or MXene particles.

In the above formula of MXene, M is preferably at least one selected from the group consisting of Ti, Zr, Hf, V, Nb, Ta, Cr, Mo, and Mn and preferably includes at least Ti, and M is more preferably at least one selected from the group consisting of Ti, V, Cr, and Mo and more preferably includes at least Ti.

The proportion of Ti atoms in M can be preferably 50 to 100 atom %, more preferably 70 to 100 atom %, and still more preferably 90 to 100 atom %.

As MXene, those having the formula MₘXₙ expressed as below are known:

Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (wherein “1.3” and “0.6” mean about 1.3 (=4/3) and about 0.6 (=2/3), respectively), Ti₃C₂, Ti₃N₂, Ti₃(CN), Zr₃C₂, (Ti, V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (MO₂Nb)C₂, (Mo₂Ta)C₂, (W₂Ti)C₂, (W₂Zr)C₂, (W₂Hf)C₂, Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (MO₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, and (Mo_{2.7}V_{1.3})C₃ (wherein “2.7” and “1.3” mean about 2.7 (=8/3) and about 1.3 (=4/3), respectively).

Typically, in the above formula, M can include Ti, and X can be a carbon atom or a nitrogen atom. Preferably, M is Ti, and X is a carbon atom. For example, a MAX phase is Ti₃AlC₂, and MXene is Ti₃C₂Tₛ (in other words, M is Ti, X is C, n is 2, and m is 3).

In the present disclosure, the MXene may contain a relatively small amount of A atoms derived from a MAX phase of a precursor, for example, in an amount of 10 mass % or less with respect to the amount of the original A atoms. The amount of remaining A atoms can be preferably 8 mass % or less, and more preferably 6 mass % or less. However, even if the amount of remaining A atoms is more than 10 mass %, no problem may be caused according to the use and conditions of use of the two-dimensional particles.

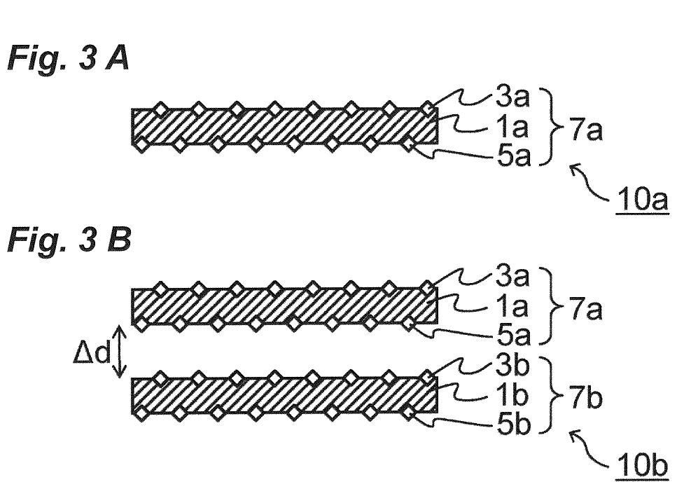

The two-dimensional particles are an aggregate containing particles of MXene (hereinafter, simply referred to as “MXene particles”) 10a of one layer (single-layer MXene particles) schematically exemplified in FIG. 3A. More specifically, the MXene particles 10a are an MXene layer 7a that includes a layer body (MₘXₙ layer) 1a represented by MₘXₙ and includes modifiers or terminals T 3a and 5a existing on a surface of the layer body 1a (more specifically, on at least one of two surfaces facing each other in each layer). Therefore, the MXene layer 7a is also represented by “MₘXₙTₛ” wherein s is any number.

The two-dimensional particles can include one or plural layers. Examples of the MXene particles of the plural layers (multilayer MXene particles) include, but are not limited to, MXene particles 10b of two layers as schematically shown in FIG. 3B. 1b, 3b, 5b, and 7b in FIG. 3B are the same as la, 3a, 5a, and 7a in FIG. 3A described above, respectively. Two adjacent MXene layers (7a and 7b, for example) in the multilayer MXene particles are not necessarily required to be completely separated from each other, and may be partially in contact with each other. The MXene particles 10a exist in the form of one layer obtained by separating the multilayer MXene particles 10b, and may be a mixture of the single-layer MXene particles 10a and multilayer MXene particles 10b that are unseparated and remaining multilayer MXene particles 10b.

Although not limiting the present embodiment, the thickness of each layer included in the MXene particles (which corresponds to the MXene layers 7a and 7b) is, for example, 0.8 to 5 nm, and particularly can be 0.8 to 3 nm (which can mainly depend on the number of M atom layers included in each layer). In each laminate of the multilayer MXene particles that can be contained, the interlayer distance (or gap dimension, which is indicated by Δd in FIG. 3B) is, for example, 0.8 to 10 nm, particularly 0.8 to 5 nm, and more particularly about 1 nm, and the total number of layers can be 2 to 20,000.

In one aspect, the ratio of (average of long diameters of two-dimensional particles on two-dimensional plane)/(average of thicknesses of two-dimensional particles) is 1.2 or more, preferably 1.5 or more, and more preferably 2 or more. The average of long diameters of two-dimensional particles on a two-dimensional plane and the average of thicknesses of the two-dimensional particles are to be determined with a method described below.

In one aspect, in the two-dimensional particles in the present embodiment, the multilayer MXene particles that can be contained preferably include two-dimensional particles obtained through a delamination process and having a small number of layers. The phrase “having a small number of layers” means, for example, that the number of stacked MXene layers is 6 or less. The multilayer MXene particles having a small number of layers preferably have a thickness in the stacking direction of 15 nm or less, and more preferably 10 nm or less. Hereinafter, the “multilayer MXene particles having a small number of layers” may be referred to as “few-layer MXene particles”. The single-layer MXene particles and the few-layer MXene particles may be collectively referred to as “single-layer/few-layer MXene particles”. If the single-layer/few-layer MXene particles are contained, the conductivity of the resulting film can be increased.

In the multilayer MXene particles having a small number of layers, the ratio of (average of long diameters of two-dimensional particles on two-dimensional plane)/(average of thicknesses of two-dimensional particles) is 1.2 or more, preferably 1.5 to 10, and more preferably 2 to 5. Hereinafter, the “MXene particles having a small number of layers” may be referred to as “few-layer MXene particles”. The single-layer MXene particles and the few-layer MXene particles may be collectively referred to as “single-layer/few-layer MXene particles”. As a result, the film containing the two-dimensional particles can have good film formability.

Examples of the single-layer/few-layer MXene particles include two-dimensional particles obtained through a delamination process.

In one aspect, the two-dimensional particles of the present embodiment preferably include the single-layer MXene particles and the few-layer MXene particles, that is, the single-layer/few-layer MXene particles. In the two-dimensional particles of the present embodiment, the proportion of the single-layer/few-layer MXene particles having a thickness of 15 nm or less is preferably 90 vol % or more, and more preferably 95 vol % or more. As a result, the film containing the two-dimensional particles can have good film formability.

The two-dimensional particles have a number average particle size of 0.001 to 4 μm, preferably 0.001 μm to 1 μm, and more preferably 0.001 μm to 0.5 μm. As a result, the adhesion between the film containing the two-dimensional particles and the substrate can be improved, and a structure can be obtained that has good bending resistance and/or stretch resistance. Although the present disclosure is not bound by any theory, it is considered that if the two-dimensional particles have a particle size in the above range, the two-dimensional particles are dispersed in the film even when a stress is applied to the structure and thus concentration of the stress can be suppressed between the film and the substrate or on the film. It is considered that for this reason, a structure excellent in bending resistance and/or stretch resistance can be obtained.

The number average particle size of the two-dimensional particles can be calculated by measuring the maximum Feret diameter for 50 or more particles in a scanning electron microscope image at a magnification of 10,000 times and determining the number average of the maximum Feret diameters. In the measurement of the maximum Feret diameter, the scanning electron microscope image may be binarized. For the binarization, image analysis software (“ImageJ” manufactured by National Institutes of Health) can be used.

The number average particle size of the two-dimensional particles is measured using a film obtained by grinding the film 30 with a mortar and a pestle, mixing the obtained powder body with water to adjust the proportion of the two-dimensional particles to 0.001 to 0.01 mass %, stirring the mixture for 12 hours or more to prepare an aqueous dispersion, and drop-casting the aqueous dispersion on a silicon substrate. The dispersion treatment of the aqueous dispersion may include a plurality of steps as necessary, and in addition to the stirring, a step may be added such as a dispersion treatment by an automatic shaker for 15 minutes, or a dispersion treatment by an ultrasonic cleaner at 40 to 200 W for 30 minutes. The surface of the silicon substrate is preferably cleaned with oxygen plasma before the drop casting.

The D50 (based on volume) measured by subjecting the mixture of the two-dimensional particles and the polymer to a laser diffraction method can be preferably 0.001 to 15 μm, more preferably 0.001 to 10 μm, and still more preferably 0.001 to 5 μm. As a result, the adhesion between the film containing the two-dimensional particles and the substrate can be improved, and a structure can be obtained that has good bending resistance and/or stretch resistance.

The measurement of the D50 of the mixture of the two-dimensional particles and the polymer with a laser diffraction method can be performed for an aqueous dispersion prepared by grinding the film 30 with a mortar and a pestle, mixing the obtained powder body with water so that the proportion of the two-dimensional particles is 0.1 to 2 mass % in the total of the water and the powder body, and stirring the mixture for 12 hours or more. The dispersion treatment of the aqueous dispersion may include a plurality of steps as necessary, and in addition to the stirring, a step may be added such as a dispersion treatment by an automatic shaker for 15 minutes, or a dispersion treatment by an ultrasonic cleaner at 40 to 200 W for 30 minutes. The measurement is performed while the prepared aqueous dispersion is added dropwise to ion-exchanged water circulating in a scattering particle size distribution measuring device (LA960 manufactured by HORIBA, Ltd.) with adjusting the amount of the added aqueous dispersion so that the obtained transmittance is, in principle, 70% to 99%. In the measurement, a two-dimensional particle complex refractive index of 1.690-0.900i is used.

### Average of Thicknesses of Two-Dimensional Particles

The average of the thicknesses of the two-dimensional particles of the present embodiment is preferably 1 to 15 nm. The thickness is preferably 10 nm or less, more preferably 7 nm or less, and still more preferably 5 nm or less. Meanwhile, considering the thickness of the single-layer MXene particles, the lower limit of the thickness of the two-dimensional particles can be 1 nm.

The average of the thicknesses of the two-dimensional particles is determined as a number average dimension (for example, a number average of at least 40 particles) based on an atomic force microscope (AFM) photograph or a transmission electron microscope (TEM) photograph.

Hereinafter, a method of producing the two-dimensional particles will be described in detail, but the present disclosure is not limited to such an embodiment.

The method of producing the two-dimensional particles includes:
(a) preparing a predetermined precursor and
(b) removing at least a part of A atoms from the precursor using an etching liquid to obtain an etched product;
(c) cleaning the etched product to obtain an etched and cleaned product;
(d) mixing the etched and cleaned product with a metal compound containing a metal cation to obtain an intercalated product in which the metal cation is intercalated into the etched and cleaned product; and
(e) stirring the intercalated product to obtain a delaminated product obtained by delaminating the intercalated product.

Hereinafter, each step will be described in detail.

### Step (a)

First, a predetermined precursor is prepared. The predetermined precursor usable in the present embodiment is a MAX phase that is a precursor of MXene, and the predetermined precursor is represented by the following formula:
MₘAXₙ
wherein M is at least one metal of Group 3, 4, 5, 6, or 7 and includes at least Ti,
X is a carbon atom, a nitrogen atom, or a combination of a carbon atom and a nitrogen atom,
A is at least one element of Group 12, 13, 14, 15, or 16,
n is 1 to 4, and
m is more than n and 5 or less.

M, X, n, and m are as described above.

A is at least one element of Group 12, 13, 14, 15, or 16. A is usually an element of Group A, typically, Group IIIA or Group IVA. More specifically, A can include at least one selected from the group consisting of Al, Ga, In, Tl, Si, Ge, Sn, Pb, P, As, S, and Cd, and is preferably Al.

The MAX phase has a crystal structure in which a layer including A atoms is located between two layers represented by MₘXₙ (each X can have a crystal lattice located in an octahedral array of M). When typically m=n+1, but not limited thereto, the MAX phase includes repeating units in which each one layer of X atoms is disposed between adjacent layers of n+1 layers of M atoms (these are also collectively referred to as an “MₘXₙ layer”) and a layer of A atoms (“A atom layer”) is disposed as a layer next to the (n+1)th layer of M atoms.

The MAX phase can be produced with a known method. For example, a TiC powder, a Ti powder, and an Al powder are mixed in a ball mill, and the obtained mixed powder is fired under an Ar atmosphere to obtain a fired body (block-shaped MAX phase). Then, the obtained fired body is crushed with an end mill, and thus a powdery MAX phase for the next step can be obtained.

### Step (b)

In the step (b), an etching process is performed in which at least a part of A atoms is removed by etching using an etching liquid from the precursor represented by MₘAXₙ. As a result, a treated product is obtained in which at least a part of the layer including A atoms is removed while the layer represented by MₘXₙ in the precursor is maintained.

The etching liquid can contain an acid such as HF, HCl, HBr, HI, sulfuric acid, phosphoric acid, or nitric acid, and typically, an etching liquid containing an F atom can be used. Examples of the etching liquid include a mixed liquid of LiF and hydrochloric acid, a mixed liquid of hydrofluoric acid and hydrochloric acid, and a mixed liquid containing hydrofluoric acid, and these mixed liquids may further contain phosphoric acid or the like. The etching liquid can be typically an aqueous solution.

As the conditions of the etching operation using the etching liquid and other conditions, conventionally performed conditions can be adopted.

### Step (c)

In the step (c), the etched product is cleaned to obtain an etched and cleaned product. The cleaning can sufficiently remove the acid and the like used in the etching process.

The cleaning can be performed using a cleaning liquid, and typically, can be performed by mixing the etched product and a cleaning liquid. Such a cleaning liquid typically contains water, and the water is preferably pure water. In addition to pure water, a small amount of hydrochloric acid or the like may be further contained. The amount of the cleaning liquid mixed with the etched product and the method of mixing the etched product and the cleaning liquid are not particularly limited. Examples of the mixing method include stirring and centrifugation under the coexistence of the etched product and the cleaning liquid. Examples of the stirring method include stirring methods using a handshaker, an automatic shaker, a shear mixer, a pot mill, or the like. The degree of stirring such as the stirring speed or the stirring time is to be adjusted according to the amount, the concentration, and the like of the etched product to be treated. The cleaning with the cleaning liquid is to be performed once or more, and is preferably performed a plurality of times. For example, specifically, the cleaning with the cleaning liquid may be performed by sequentially performing a step (i) of adding the cleaning liquid (to the treated product or the remaining precipitate obtained in the following (iii)) and stirring the resulting mixture, a step (ii) of centrifuging the stirred product, and a step (iii) of discarding the supernatant after the centrifugation, and the steps (i) to (iii) may be repeated within a range of 2 times or more and, for example, 15 times or less.

### Step (d)

In the step (d), an intercalation process is performed in which a metal cation is intercalated into the etched and cleaned product using a metal compound containing a metal cation, and thus an intercalated product is obtained. As a result, an intercalated product is obtained in which the metal cation is intercalated between two adjacent MₘXₙ layers. Such an intercalation process may be performed in a dispersion medium.

The metal cation can be the same as a metal cation contained in the two-dimensional particles, and may include a Li cation or another metal cation.

However, the metal of the metal cation is different from the M atom. Furthermore, the metal of the metal cation is different from the A atom contained in the precursor.

Examples of the metal compound include ionic compounds in which the metal cation and an anion are bonded. Examples of the metal compound include iodides, phosphates, sulfide salts including sulfates, nitrates, acetates, and carboxylates of the metal cation. The metal cation is preferably a lithium ion, and the metal compound is preferably a metal compound containing a lithium ion, more preferably an ionic compound of a lithium ion, and still more preferably one or more among iodides, phosphates, and sulfide salts of a lithium ion. It is considered that if a lithium ion is used as the metal ion, a monolayer is easily formed because water hydrated to the lithium ion has the most negative dielectric constant.

A specific method of the intercalation process is not particularly limited, and for example, a mixture of the etched and cleaned product and the metal compound may be stirred, or may be left to stand. For example, the mixture is stirred at room temperature. Examples of the stirring method include methods using a stirring bar such as a stirrer, a stirring blade, a mixer, or a centrifugal device, and the stirring time can be set according to the production scale of the single-layer/few-layer MXene particles, and can be set to, for example, in the range of 12 to 24 hours.

The intercalation process may be performed in the presence of a dispersion medium. Examples of the dispersion medium include water and organic media such as N-methylpyrrolidone, N-methylformamide, N,N-dimethylformamide, methanol, ethanol, dimethylsulfoxide, ethylene glycol, and acetic acid.

The order of mixing the dispersion medium, the etched and cleaned product, and the metal compound is not particularly limited, and in one aspect, mixing of the dispersion medium and the etched and cleaned product may be followed by mixing with the metal compound. Typically, the etching liquid after the etching process may be used as the dispersion medium.

The intercalation process can be typically performed on the etched and cleaned product, but in another aspect, may be performed on the precursor simultaneously with the etching process. Specifically, such an etching and intercalation process includes mixing a precursor, an etching liquid, and a metal compound containing a metal cation and thus removing at least a part of A atoms from the precursor and intercalating the metal cation into the precursor after the removal of A atoms to obtain an intercalated product. As a result, at least a part of A atoms are removed from the precursor (MAX), and the MₘXₙ layer in the precursor remains. Thus, an intercalated product is obtained in which the metal cation is intercalated between the plurality of adjacent MₘXₙ layers.

As the etching liquid and the metal compound used in the etching and intercalation process, the same etching liquid and the same metal compound as those used in the step (b) can be used, respectively.

### Step (e)

In the step (e), the intercalated product is stirred to perform a delamination process of delaminating the intercalated product, and thus a delaminated product is obtained. Such stirring applies a shear stress to the intercalated product, and thus two adjacent MₘXₙ layers can be separated at least partially, and the MXene particles can be formed into a single layer or a few layers.

Conditions of the delamination process are not particularly limited, and the delamination process can be performed with a known method. Examples of the method of applying a shear stress to the intercalated product include a method in which the intercalated product is dispersed in a dispersion medium and stirred. Examples of the stirring method include stirring using a mechanical shaker, a vortex mixer, a homogenizer, an ultrasonic treatment, a handshaker, an automatic shaker, or the like. The degree of stirring such as the stirring speed or the stirring time is to be adjusted according to the amount, the concentration, and the like of the product to be treated. For example, the slurry after the intercalation is centrifuged, the supernatant is discarded, then pure water is added to the remaining precipitate, and the resulting mixture is stirred by, for example, a handshake or an automatic shaker to separate layers. An unseparated substance is removed, for example, by a step in which, after the centrifugation and the discarding of the supernatant, the remaining precipitate is cleaned with water. For example, (i) pure water is added to the remaining precipitate after the discarding of the supernatant, and the resulting mixture is stirred, (ii) the mixture is centrifuged, and (iii) the supernatant is collected. Operation of (i) to (iii) is repeated once or more, and preferably 2 times to 10 times to obtain a supernatant containing single-layer/few-layer MXene particles, as a delaminated product. Alternatively, a step may be performed in which the supernatant is centrifuged and the supernatant after the centrifugation is discarded to obtain a clay containing single-layer/few-layer MXene particles, as a delaminated product.

The delaminated product may be further cleaned. Such cleaning can remove an impurity and the like at least partially. Hereinafter, a treated product obtained by cleaning the delaminated product is also referred to as a delaminated and cleaned product, and the delaminated and cleaned product is included in the technical scope of the delaminated product.

In one aspect, the cleaning can be performed using a cleaning liquid, and typically, can be performed by mixing the delaminated product and a cleaning liquid. In another aspect, the cleaning can be performed by acid-treating the delaminated product and then mixing the acid-treated product and a cleaning liquid. An appropriate acid may be used as the acid, and examples of the acid include inorganic acids such as hydrochloric acid, sulfuric acid, nitric acid, phosphoric acid, perchloric acid, hydroiodic acid, hydrobromic acid, and hydrofluoric acid and organic acids such as acetic acid, citric acid, oxalic acid, benzoic acid, and sorbic acid. The concentration of the acid in an acid solution can be appropriately adjusted according to the delaminated product. The cleaning with the cleaning liquid may be performed by sequentially performing a step (i) of adding the cleaning liquid (to the treated product or the remaining precipitate obtained in the following (iii)) and stirring the resulting mixture, a step (ii) of centrifuging the stirred product, and a step (iii) of discarding the supernatant after the centrifugation, and the steps (i) to (iii) may be repeated within a range of 2 times or more and, for example, 15 times or less. The stirring can be performed using a handshaker, an automatic shaker, a shear mixer, a pot mill, or the like. The acid treatment is to be performed once or more, and an operation may be performed in which the delaminated product is mixed with a fresh acid solution (acid solution unused in an acid treatment) and stirred, as necessary, within a range of 2 times or more and, for example, 10 times or less. As the cleaning liquid, the same as the cleaning liquid in the step (c) can be used. For example, specifically, water may be used as the cleaning liquid, and pure water is preferable. The mixing can be performed with the same method as the mixing method in the step (c), and specific examples of the mixing method include stirring and centrifugation. Examples of the stirring method include stirring methods using a handshaker, an automatic shaker, a shear mixer, a pot mill, or the like.

The intermediate and the target product in the above-described production method, for example, the intercalated product and the delaminated product may be dried by suction filtration, heat drying, freeze drying, vacuum drying, or the like.

The proportion of the two-dimensional particles in the film 30 is 5 to 75 vol %, and can be preferably 5 to 70 vol %, more preferably 5 vol % to 40 vol %, and most preferably 45 vol % to 70 vol %, in 100 vol % of the total of the two-dimensional particles and the polymer. In the structure of the present disclosure, the two-dimensional particles contained in the film 30 have good dispersibility, and even if the two-dimensional particles are contained at a high proportion, the structure can have good bending resistance and/or stretch resistance.

The film 30 further contains the polymer in addition to the two-dimensional particles. If the film 30 contains the polymer, the flexibility of the film 30 is improved, and the bending resistance and/or the stretch resistance can be improved.

The polymer preferably contains a polymer material having a group capable of exhibiting electrostatic interaction such as hydrogen bonding or interionic interaction. It is considered that if such a polymer material is contained, interaction can occur between the group capable of exhibiting electrostatic interaction and the two-dimensional particles and thus the bending resistance and/or the stretch resistance of the obtained film can be improved.

Although the present disclosure is not bound by any theory, the following is considered as the reason why interaction occurs between the group capable of exhibiting electrostatic interaction and the two-dimensional particles to improve the bending resistance and/or the stretch resistance of the obtained film. That is, it is considered that the two-dimensional particles include the layer represented by MₘXₙ having a surface that includes a modifier or terminal T (T is at least one selected from the group consisting of a hydroxyl group, a fluorine atom, a chlorine atom, an oxygen atom, and a hydrogen atom) and includes a charged site. Therefore, it is considered that if the polymer material contains a group capable of exhibiting electrostatic interaction, electrostatic interaction can occur between the group and the charged site. Therefore, it is considered that in the obtained film, the polymer and the two-dimensional particles are easily bonded by electrostatic interaction and thus the bending resistance and/or the stretch resistance can be improved.

Examples of the atom or the group capable of forming the hydrogen bonding (hereinafter, these are also collectively referred to as a “hydrogen bonding group”) include one selected from the group consisting of a fluorine atom, a chlorine atom, an oxygen atom, and a nitrogen atom, as an atom capable of acting as a hydrogen acceptor (hereinafter, also referred to as a “hydrogen acceptor atom”), and include a hydroxyl group and/or a secondary amino group as a group capable of acting as a hydrogen donor (hereinafter, also referred to as a “hydrogen donor group”).

Examples of the group capable of exhibiting interionic interaction include anionic groups and cationic groups. Examples of the anionic groups include a carboxylic acid group, carboxylates, a sulfonic acid group, and sulfonates, and examples of the cationic groups include an amino group and quaternary ammonium bases.

In one aspect, the polymer preferably contains a polymer material (1) having a hydrogen bonding group. It is considered that the strength of the film can be increased by using the polymer material (1).

Although the present disclosure is not bound by any theory, the following is considered as the reason why the strength of the film can be increased by using the polymer material (1) having a hydrogen bonding group. That is, in the modifier or terminal T of the two-dimensional particles, a hydroxyl group and a hydrogen atom can act as a hydrogen donor in the hydrogen bonding, and a fluorine atom, a chlorine atom, and an oxygen atom can act as a hydrogen acceptor in the hydrogen bonding. Therefore, in a case where a polymer material having a hydrogen acceptor atom is used as the hydrogen bonding group, it is considered that the hydrogen acceptor atom can form hydrogen bonding with a hydroxyl group or a hydrogen atom present as the modifier or terminal T on the layer surface of the two-dimensional particles. Similarly, in a case where a polymer material having a hydrogen donor group is used, it is considered that the hydrogen donor group can form hydrogen bonding with a fluorine atom, a chlorine atom, or an oxygen atom present as the modifier or terminal T on the layer surface of the two-dimensional particles. As a result, it is considered that the layers of the two-dimensional particles are loosely crosslinked to each other by the polymer material having a hydrogen bonding group to improve the toughness of the film and thus the bending resistance and/or the stretch resistance can be improved. As a result, it is also expected that an increase in the interplanar distance of the two-dimensional particles can be suppressed and thus a decrease in the conductivity can be suppressed.

Meanwhile, in a case where a polymer material having no hydrogen bonding group is interposed between the layers of the two-dimensional particles, it is considered that a repulsive force acts between the layers of the two-dimensional particles due to steric interaction to push the layers apart from each other and thus the interplanar distance of the two-dimensional particles is also increased. As a result, it is considered to be difficult to suppress a decrease in the conductivity of a film containing the polymer material having no hydrogen bonding group and the two-dimensional particles.

The polymer material (1) preferably contains at least one selected from hydrogen acceptor atoms and hydrogen donor groups, and more preferably contains a hydrogen acceptor atom and a hydrogen donor group. It is considered that if the polymer material (1) contains both a hydrogen acceptor atom and a hydrogen donor group, the number of hydrogen bonds that can be formed between the polymer material (1) and the two-dimensional particles is increased to exhibit effects of improving the film strength and suppressing a decrease in the conductivity more easily.

Examples of the polymer material (1) include polymers having a hydrogen donor group such as polyethyleneimine (PEI), polypyrrole (PPy), and polyaniline (PANI), polymers having a hydrogen acceptor atom such as polyimides (PIs), polyesters, polycarbonate, polyethers, and polylactic acid, polymers having a hydrogen donor group and a hydrogen acceptor atom such as polyimides (PIs) containing a secondary amino group like a flame-retardant polyimide, polyamideimide (PAI), polyacrylamide (PMA), polyamide resins (such as nylon), deoxyribonucleic acid (DNA), and polyurethanes, acetanilide, and acetaminophen.

Among them, a polymer material having an amide bond (—NH—CO—) is more preferable, and a polymer material having a urethane bond (—NH—CO—O—) is still more preferable. The polymer material having an amide bond has high affinity with the two-dimensional particles, can form a smooth film, and can contribute to improvement in the conductivity. Furthermore, the polymer material having a urethane bond has higher affinity with the two-dimensional particles, and can form a smoother film. As a result, both higher conductivity and high strength can be achieved.

The polymer material having an amide bond is more preferably a polyurethane, and still more preferably a polyether/carbonate-based polyurethane, that is, a polyurethane containing a unit derived from a polyether and a unit derived from polycarbonate.

In one aspect, the polymer preferably contains an anionic polymer (2) having at least one of a carboxylic acid group or a carboxylate group and having no NH group. If the anionic polymer (2) is contained, the two-dimensional particles have good dispersibility in the film, and the bending resistance and/or the stretch resistance can be improved. Furthermore, the environmental resistance (particularly moisture resistance) is expected to improve.

Although the present disclosure is not bound by any theory, the following is considered as the reason why the two-dimensional particles have good dispersibility in the film, the bending resistance and/or the stretch resistance can be improved, and the environmental resistance (particularly moisture resistance) of the film is expected to improve, by using the anionic polymer (2).

As described above, the two-dimensional particles include a layer body represented by MₘXₙ having a surface that includes the modifier or terminal T (T is at least one selected from the group consisting of a hydroxyl group, a fluorine atom, a chlorine atom, an oxygen atom, and a hydrogen atom). The charged site is included in such a configuration, and a two-dimensional sheet plane (a plane parallel to a layer of the two-dimensional particles) occupying most of the surface of the two-dimensional particles usually has a negative charge. In the modifier or terminal T of the two-dimensional particles, a fluorine atom, a chlorine atom, and an oxygen atom can function as a hydrogen acceptor in the hydrogen bonding, and a hydroxyl group and a hydrogen atom can function as a hydrogen donor in the hydrogen bonding.

Meanwhile, the anionic polymer (2), which has at least one of a carboxylic acid group or a carboxylate group and has no NH group, can generate —C(═O)O⁻ in a liquid medium. Then, ═O in the carboxylic acid group and/or the carboxylate group can function as a hydrogen acceptor in the hydrogen bonding, and H in the carboxylic acid group can function as a hydrogen donor in the hydrogen bonding.

The two-dimensional particles mixed with a liquid medium (typically, water) can attract each other by an intermolecular force or a hydrogen bonding force and aggregate in the liquid medium, but if the anionic polymer (2) coexists therein, loose hydrogen bonding can be formed between the two-dimensional particles and the anionic polymer while the negative charge on the surface of the two-dimensional particles and —C(═O)O⁻ of the anionic polymer (2) electrostatically repel each other strongly (note that the anionic polymer includes a plurality of monomer units having a carboxylic acid group and/or a carboxylate group). Therefore, in the liquid medium, the electrostatic repulsion between the negative charge on the surface of the two-dimensional particles and the anionic polymer and the hydrogen bonding are suitably balanced, and as a result, the two-dimensional particles are effectively prevented from aggregating by steric repulsion of the anionic polymer, and thus can be well dispersed. The two-dimensional particles are extremely sensitive to a functional group of the polymer, and can be well dispersed by using the anionic polymer (2) having a carboxylic acid group and/or a carboxylate group, which is capable of forming loose hydrogen bonding and capable of electrostatic repulsion by anionicity, among anionic functional groups.

The good dispersibility of the two-dimensional particles can be ensured if the anionic polymer has no NH group. An NH group can function as a cationic functional group. Furthermore, an NH group can function as a hydrogen donor, and the MXene particles can form strong hydrogen bonding with an NH group. If the anionic polymer has an NH group, an electrostatic attractive force acts between the negative charge on the surface of the MXene particles and the NH group of the anionic polymer in a liquid medium, or too strong hydrogen bonding acts between the MXene particles and the NH group of the anionic polymer to connect the MXene particles to each other via the anionic polymer, and thus aggregation of the MXene particles can occur. In the present embodiment, the anionic polymer (2) has no NH group, so that such a problem can be avoided.

If the two-dimensional particles have good dispersibility in the anionic polymer (2) as described above, the two-dimensional particles can be densely present in the film. If the two-dimensional particles have good dispersibility, it is considered that the two-dimensional particles can be uniformly dispersed even in the obtained film. As a result, it is considered that even when a stress is applied, concentration of the stress on a specific portion can be suppressed and thus the bending resistance and/or the stretch resistance can be improved. Furthermore, a film can be easily obtained in which the two-dimensional particles are present at a high density, and thus the film is less likely to be affected by the surrounding environment, and therefore the environmental resistance can be expected to be improved (more than in a conventional case).

Meanwhile, in a liquid composition in which the MXene particles have poor dispersibility, it is considered that the MXene particles are unevenly distributed in a liquid medium and partially aggregated, unlike in the present embodiment. Even in a precursor structure formed using such a liquid composition, it is considered that the MXene particles are unevenly distributed in the liquid medium and partially aggregated, and at the time of drying (film formation), the orientation of the MXene particles is interfered and disturbed by the aggregated MXene particles. As a result, a gap is generated in the vicinity of the aggregated MXene particles, and a film having a low density of MXene particles is formed. In this case, it is considered that when a stress is applied to the film, the stress tends to concentrate in the vicinity of the gap and the bending resistance and/or the stretch resistance are not sufficiently satisfied. Furthermore, a composite material having a low density of MXene particles is easily affected by the surrounding environment, and thus the environmental resistance deteriorates (as in a conventional composite material). For example, it is considered that under a high humidity condition, water molecules easily enter a composite material having a lower density of MXene particles (and having more water molecule entry paths) and thus the moisture resistance deteriorates.

As understood from the above, if the anionic polymer (2) is used, the two-dimensional particles have good dispersibility, and a film is obtained in which the density of MXene particles is high and thus the bending resistance and/or the stretch resistance is good. Furthermore, it is expected that the film can have better environmental resistance (particularly moisture resistance) than a conventional composite material.

Furthermore, the anionic polymer (2) is preferably a self-crosslinking resin material although this condition is not essential to the present embodiment. As a result, the environmental resistance (particularly moisture resistance) can be further improved. Although the present disclosure is not bound by any theory, the reason is considered as follows.

The self-crosslinking resin material can be a resin material in which a self-crosslinking functional group and/or a reactive functional group (capable of reacting with a crosslinking agent) is introduced into the anionic polymer (2). The two-dimensional particles can have a hydroxyl group or the like as the modifier or terminal T, and the modifier or terminal T can cause a crosslinking reaction with the self-crosslinking functional group and/or the reactive functional group of the anionic polymer (2). If the anionic polymer (2) crosslinked to a two-dimensional particle is further crosslinked to another two-dimensional particle, the plurality of two-dimensional particles are crosslinked to each other with the anionic polymer (2). The two-dimensional particles crosslinked in this manner are chemically bonded to each other and are less likely to be affected by the surrounding environment, so that the environmental resistance can be further improved. For example, under a high humidity condition, the two-dimensional particles are less likely to be separated by water molecules, and thus the moisture resistance can be further improved.

The polymer may contain both the polymer material (1) and the anionic polymer (2), or may contain either the polymer material (1) or the anionic polymer (2). In one aspect, the polymer contains the polymer material (1), and in another aspect, the polymer contains the anionic polymer (2).

The total content of the polymer material (1) and the anionic polymer (2) in 100 mass % of the polymer can be preferably 70 to 100 mass %, more preferably 80 to 100 mass %, and still more preferably 90 to 100 mass %.

The polymer may contain another polymer in addition to the polymer (1) and the anionic polymer (2). Examples of another polymer include polyolefins and polystyrene.

A case is preferably excluded in which the polymer contains polyvinyl alcohol (PVA). The present inventors have confirmed that PVA has extremely strong action of aggregating two-dimensional particles. Therefore, for example, even if the polymer containing PVA contains the anionic polymer (2), the aggregation action by PVA can be stronger than the effect of electrostatic repulsion between the negative charge on the surface of the two-dimensional particles and —C(═O)O⁻ of the anionic polymer (2) in the liquid medium, and therefore if polyvinyl alcohol (PVA) is not contained, the two-dimensional particles can easily have good dispersibility in the polymer.

The total proportion of carbon atoms and nitrogen atoms on the surface of the film 30 measured by X-ray photoelectron spectroscopy is preferably 0.67 to 25 atom %, and more preferably 5 to 20 atom % with respect to 100 atom % of M atoms on the surface of the film 30. In the X-ray photoelectron spectroscopy, information of elements can be acquired from the outermost surface of the sample to a depth of several tens of nm. In the film 30 of the present disclosure, the presence of the M atom derived from the two-dimensional particles can be confirmed even in the case of using X-ray photoelectron spectroscopy for measurement, and as a result, it is inferred that the two-dimensional particles are well dispersed in the film 30.

In one aspect, in a case where MₘXₙ is Ti₃C₂ and the film contains a polyurethane as the polymer, the total proportion of carbon atoms and nitrogen atoms on the surface of the film 30 measured by X-ray photoelectron spectroscopy can be preferably 10 to 20 atom % with respect to 100 atom % of Ti atoms on the surface of the film 30.

The content of the two-dimensional particles in the film 30 can be preferably 5 to 75 vol %, more preferably 5 to 70 vol %, still more preferably 5 to 40 vol %, and most preferably 45 to 70 vol %, with respect to 100 vol % of the total of the two-dimensional particles and the polymer that can be contained in the film 30. In a structure 100, the two-dimensional particles contained in the film 30 have good dispersibility, and even if the two-dimensional particles are contained at a high proportion, the structure can have good bending resistance and/or stretch resistance.

The film 30 may contain another additive in addition to the two-dimensional particles and the polymer used as necessary.

A method of forming the structure in the present embodiment includes:
(f) preparing a liquid composition containing the two-dimensional particles and a liquid medium, and dispersing the liquid composition to prepare a liquid dispersion; and
(g) forming a precursor film on a substrate using the liquid dispersion, and forming the precursor film into a film by at least drying to obtain a structure.

Hereinafter, each step will be described in detail.

### Step (f)

In the step (f), a liquid composition is prepared that contains the two-dimensional particles, a liquid medium, and a polymer used as necessary, and the liquid composition is dispersed to prepare a liquid dispersion. The order of mixing and dispersing the two-dimensional particles, the liquid medium, and the polymer used as necessary is not particularly limited, and may be such that the two-dimensional particles and the liquid medium are mixed and dispersed, then the polymer is mixed, and the resulting mixture is further dispersed as necessary, or may be such that the two-dimensional particles, the liquid medium, and the polymer are mixed and then dispersed. As the two-dimensional particles, the delaminated product can be used, but the present disclosure is not limited thereto.

The liquid medium may be an aqueous medium or an organic medium, and is preferably an aqueous medium. The aqueous medium is typically water, and in some cases, another liquid substance may be contained in a relatively small amount (e.g., 30 mass % or less, and preferably 20 mass % or less based on the whole mass of the aqueous medium) in addition to water. The organic medium may be, for example, a protic solvent such as an alcohol, an aprotic solvent, or a mixture of a protic solvent and an aprotic solvent.

In the liquid composition, the total content of the two-dimensional particles and the polymer used as necessary can be, for example, 0.1 to 30 mass %, and preferably 1 to 10 mass %. The proportion of the two-dimensional particles in the total of the two-dimensional particles and the polymer in the composition can be the same as the proportion of the two-dimensional particles in the total of the two-dimensional particles and the polymer in the resulting film.

The mixing can be performed, for example, by stirring using a handshaker, an automatic shaker, a shear mixer, a pot mill, or the like.

The dispersion may be performed using a dispersing device such as a homogenizer, a probe type ultrasonic homogenizer, a propeller stirrer, a thin-film spin system stirrer, a planetary mixer, a mechanical shaker, a vortex mixer, a high-pressure disperser, or an ultrasonic cleaner. The dispersion may be performed using a plurality of devices, and is preferably performed using a high-pressure disperser, an ultrasonic cleaner, and a thin-film spin system stirrer, and particularly preferably using a high-pressure disperser and an ultrasonic cleaner. In some cases, the two-dimensional particles and water may be sufficiently dispersed together with the polymer using a conventional mechanical shaker by a dispersion treatment of the two-dimensional particles and water with a high-pressure disperser, an ultrasonic cleaner, or a thin-film spin system stirrer.

In particular, the dispersion is preferably performed according to any one of the following (i) to (iii), more preferably performed according to the following (i) or (ii), and still more preferably performed according to the following (i). As a result, the particle size of the two-dimensional particles can be easily adjusted to a predetermined range.
(i) The liquid dispersion is pressurized to an absolute pressure of 100 to 300 MPa, ejected from a nozzle having a nozzle diameter of 50 to 200 μm, and collided with a medium for dispersion.
(ii) The liquid dispersion is put into a container, and the container is continuously irradiated for 1 minute or more with an ultrasonic wave having a frequency of 30 to 50 kHz emitted from two or more different oscillators in a state where the container is rotated at a rotation speed of 80 to 600 rpm.
(iii) The liquid dispersion is put into a cylindrical container, the central axis of the cylindrical container is set as a rotation axis, and the cylindrical container is continuously rotated for 1 minute or more at a peripheral speed of 5 m/min or more in a state where the liquid dispersion spreads in a thin-film shape on a side surface of the cylindrical container.

As the medium for dispersion in the above (i), a ceramic ball may be used.

### Step (g)

In the step (g), a precursor film is formed on the substrate using the liquid dispersion prepared above, and the precursor film is formed into a film by at least drying to obtain a structure.

The method of forming the precursor film on the substrate is not particularly limited, and for example, the precursor film may be formed by spraying the liquid dispersion on the substrate. The spraying can orient the MXene particles on the substrate (align the MXene particles so that the two-dimensional sheet plane of the MXene particles is substantially parallel (for example, within ±20°) to the surface of the substrate), and can make the finally obtained structure denser than a filtration membrane, and thus higher environmental resistance (moisture resistance) can be obtained. In addition, any method such as filtration, bar coating, spin coating, or immersion can be applied. The substrate may be subjected to a pretreatment such as an oxygen plasma treatment or an ozone treatment before forming the precursor film on the substrate.

The drying of the precursor film removes an unnecessary liquid medium (the entire liquid medium is not necessarily removed, and a part of the liquid medium may remain) to form a structure. In order to obtain a structure having a film of a desired thickness, the spraying and the drying may be repeated.

In the case of using the self-crosslinking anionic polymer (2) as the polymer, a crosslinking reaction can be promoted while the structure is formed. For example, a crosslinking reaction may be promoted by removing the liquid medium at least partially by drying. Alternatively, for example, a crosslinking reaction may be promoted by drying, and in addition, heating, irradiation with a radiation (such as light or ultraviolet light), and the like under appropriate conditions according to the self-crosslinking anionic polymer (2) to be used.

In the present embodiment, the film 30 is in contact with the entire surface of the substrate 50, but the present disclosure is not limited thereto, and the film 30 is to be in contact with at least a part of the substrate 50. In FIG. 2, the surface of the film 30 is parallel to the surface of the substrate 50, but the present disclosure is not limited thereto.

### Second Embodiment

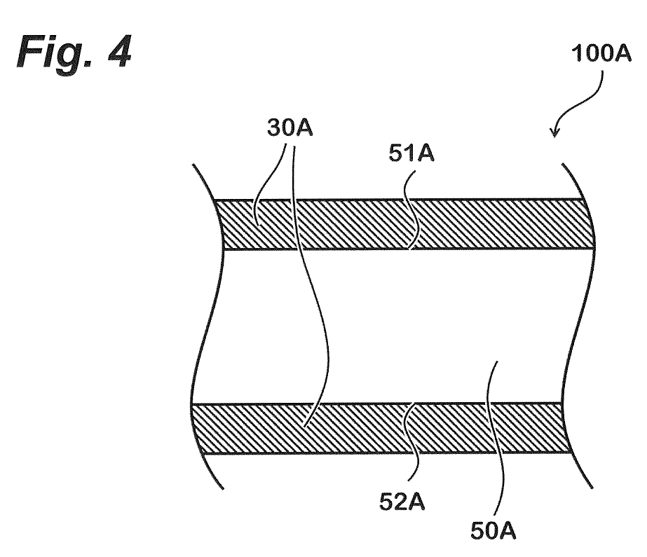

FIG. 4 is a sectional view of a structure according to the present embodiment. Second Embodiment is different from First Embodiment in that a substrate 50A has an upper surface 51A and a lower surface 52A and a film 30A is in contact with each of the upper surface 51A and the lower surface 52A. Such a different configuration will be described below. The other configurations are the same as those of First Embodiment, and are denoted by the same reference signs as those of First Embodiment, and the description thereof will be omitted.

As shown in FIG. 4, the structure in the present embodiment includes the substrate 50A and the film 30A. The substrate 50A has the upper surface 51A and the lower surface 52A, and the film 30A is in contact with each of the upper surface 51A and the lower surface 52A.

The film 30A in contact with the upper surface 51A and the film 30A in contact with the lower surface 52A may be the same or different. The substrate 50A may include a plurality of substrates that are stacked.

In FIG. 4, the upper surface 51A and the lower surface 52A are parallel to each other, but the present disclosure is not limited thereto. In FIG. 4, the film 30A in contact with the upper surface 51A and the film 30A in contact with the lower surface 52A are separated, but the present disclosure is not limited thereto, and the film 30A in contact with the upper surface 51A and the film 30A in contact with the lower surface 52A may be continuous.

The present disclosure is not limited to the above-described embodiments, and can be modified in design without departing from the gist of the present disclosure.

For example, in First Embodiment and Second Embodiment, the film has one layer, but the present disclosure is not limited thereto, and the number of layers of the film can be adjusted to any number. Specifically, in First Embodiment and Second Embodiment, the structure may include two layers of films. In this case, the plurality of films may have the same configuration or different configurations. In such an aspect, the proportion of the two-dimensional particles in the film in contact with the substrate may be higher than, lower than, or the same as the proportion of the two-dimensional particles in the film disposed on the film in contact with the substrate. In a case where the proportion of the two-dimensional particles in the film in contact with the substrate is lower than the proportion of the two-dimensional particles in the film disposed on the film in contact with the substrate, the adhesion between the substrate and the film in contact with the substrate is improved, and the conductivity of the film disposed on the film in contact with the substrate can be increased.

<1> A structure comprising:
one or more substrates having flexibility; and
one or more films in contact with at least a part of a surface of the one or more substrates,
wherein the one or more films contain two-dimensional particles including one or plural layers, and the one or more films contain a polymer,
wherein the one or plural layers include:
a layer body represented by:
MₘXₙ
wherein M is at least one metal of Group 3, 4, 5, 6, or 7,
X is a carbon atom, a nitrogen atom, or a combination of a carbon atom and a nitrogen atom,
n is 1 to 4, and
m is more than n and 5 or less; and
a modifier or terminal T exists on a surface of the layer body, wherein T is at least one selected from a hydroxyl group, a fluorine atom, a chlorine atom, an oxygen atom, and a hydrogen atom,
wherein a proportion of the two-dimensional particles in the one or more films is 5 to 75 vol % based on 100 vol % of a total of the two-dimensional particles and the polymer, and
wherein the two-dimensional particles have a number average particle size of 0.001 to 4 μm.

<2> The structure according to <1>, wherein a D50 determined by measuring a mixture of the two-dimensional particles and the polymer with a laser diffraction method is 0.001 μm to 15 μm.

<3> The structure according to <1> or <2>, wherein the two-dimensional particles have a number average particle size of 0.001 μm to 1 μm.

<4> The structure according to any one of <1> to <3>, wherein
the MₘXₙ is M₃X₂, and
a total proportion of carbon atoms and nitrogen atoms on a surface of the one or more films measured by X-ray photoelectron spectroscopy is 0.67 atom % to 25 atom % with respect to 100 atom % of atoms of M on the surface of the one or more films.

<5> The structure according to any one of <1> to <4>, wherein the polymer contains a polymer material having:
at least one selected from a fluorine atom, a chlorine atom, an oxygen atom, and a nitrogen atom, as a hydrogen acceptor; and
a hydroxyl group and/or a secondary amino group as a hydrogen donor.

<6> The structure according to any one of <1> to <5>, wherein the polymer contains a polymer material having a urethane bond.

<7> The structure according to any one of <1> to <6>, wherein the polymer contains an anionic resin material excluding polyvinyl alcohol, the anionic resin material containing an anionic polymer, the anionic polymer having at least one of a carboxylic acid group or a carboxylate group and having no NH group.

<8> The structure according to any one of <1> to <7>, wherein the polymer contains an acrylic resin.

<9> The structure according to any one of <1> to <8>, wherein the proportion of the two-dimensional particles in the one or more films is 45 to 70 vol %.

### EXAMPLES

The present disclosure will be described more specifically with reference to the following Examples, but the present disclosure is not limited thereto.

### Example 1

### [Preparation of Two-Dimensional Particles]

In Example 1, two-dimensional particles were prepared by performing the steps described in detail below of (1) Preparation of precursor (MAX), (2) Etching of precursor, (3) Cleaning, (4) Intercalation, and (5) Delamination and cleaning, in this order.

### (1) Preparation of Precursor (MAX)

A TiC powder, a Ti powder, and an Al powder (all manufactured by Kojundo Chemical Laboratory. Co., Ltd.) were put into a ball mill containing zirconia balls at a molar ratio of 2:1:1 and mixed for 24 hours. The obtained mixed powder was fired in an Ar atmosphere at 1350° C. for 2 hours. The fired body (block) thus obtained was crushed with an end mill to a maximum size of 40 μm or less. Thus, Ti₃AlC₂ particles were obtained as MAX particles.

(2) Etching of Precursor (ACID method)

Using the Ti₃AlC₂ particles (powder) prepared with the above method, etching was performed under the following etching conditions to obtain a solid-liquid mixture (slurry) containing a solid component derived from the Ti₃AlC₂ powder.

### (Etching Conditions)

Precursor: Ti₃AlC₂ (sieved at a mesh size of 45 μm)
Etching liquid composition: 49% HF 6 mL
   H₂O 18 mL
   HCl (12M) 36 mL
Amount of fed precursor: 3.0 g
Etching container: 100 mL wide-mouth bottle
Etching temperature: 35° C.
Etching time: 24 h
Stirrer rotation speed: 400 rpm

### (3) Cleaning

The slurry was divided into two parts, the parts were respectively put into two 50 mL centrifuge tubes, and centrifuged using a centrifuge under the condition of 3500 G, and then each supernatant was discarded. The following operation was repeated 11 times. To the remaining precipitate in each centrifuge tube, 40 mL of pure water was added, and the resulting product was centrifuged again at 3500 G to separate and remove the supernatant. After final centrifugation, the supernatant was discarded to obtain a Ti₃C₂Tₓ-water medium clay.

### (4) Intercalation

The Ti₃C₂Tₛ-water medium clay and LiCl as a Li-containing compound were used under the following conditions, and stirred at 20 to 25° C. for 12 hours to perform Li intercalation.

### (Conditions of Li Intercalation)

Ti₃C₂Tₓ-water medium clay (MXene after cleaning): solid content 0.75 g
LiCl: 0.75 g
Intercalation container: 100 mL wide-mouth bottle
Temperature: 20 to 25° C. (room temperature)
Time: 10 h
Stirrer rotation speed: 800 rpm

### (5) Delamination and Cleaning

To the Ti₃C₂Tₓ-water medium clay, (i) 40 mL of pure water was added, the resulting mixture was stirred with a shaker for 15 minutes, then (ii) the mixture was centrifuged at 3,500 G, and (iii) the supernatant was collected as a single-layer MXene-containing liquid. The operation of (i) to (iii) was repeated four times in total to obtain a single-layer MXene-containing supernatant. This supernatant was centrifuged using a centrifuge under the conditions of 4,300 G and 2 hours, and then the supernatant was discarded to obtain a clay containing a delaminated product.

### [Preparation of MXene-Water Dispersion]

Appropriate amounts of the clay containing the delaminated product and pure water were mixed to prepare a MXene-water dispersion (MXene slurry) having a solid content concentration (MXene particle concentration) of 34 mg/mL.

### [Preparation of Liquid Composition]

The MXene slurry, pure water, and a polyurethane (“RESAMINE D-4080” manufactured by Dainichiseika Color & Chemicals Mfg. Co., Ltd., polyether/polycarbonate-based polyurethane) were blended so that the proportion of MXene (Ti₃C₂Tₓ) in the solid content (component excluding pure water) was 30 vol %, and the blend was shaken and stirred for 15 minutes using an automatic shaker (“SK550 1.1” manufactured by Fast & Fluid) to prepare a liquid composition containing MXene particles and a resin material.

### [Preparation of Liquid Dispersion]

The obtained liquid composition was subjected to a dispersion treatment using a wet atomization device (“STAR BURST MINI” manufactured by Sugino Machine Limited) with a nozzle having a diameter set to 0.12 mm and ceramic balls having a diameter of 1.23 cm serving as a dispersion medium at a pressure set to 200 MPa to obtain a liquid dispersion.

### [Preparation of Structure]

The obtained liquid dispersion was sprayed using a spray coater onto a liquid crystal polymer film having a thickness of 50 μm, which was a 5 cm square substrate whose surface was cleaned with oxygen plasma in advance, to form a precursor film, and then the precursor film was dried with hot air. The spraying and the drying were each repeated 30 times in total.

### (Conditions of Spray Coating)

Atomization pressure: 0.5 MPa
Distance between nozzle tip and substrate: 15 cm
Liquid feeding amount: 5 mL/s
Sweep speed: 150 mm/s
Stage heater: 45° C.

Then, the precursor film was dried at 80° C. for 2 hours in a normal pressure oven and further dried at 150° C. for 15 hours in a vacuum oven to form a film, and thus a structure was obtained.

### Example 2

A liquid dispersion was prepared in the same manner as in Example 1.

### [Preparation of Structure]

A structure was prepared in the same manner as in Example 1 except that a polyethylene terephthalate (PET) substrate (“Lumirror” (registered trademark) manufactured by Toray Industries, Inc., 50 μm) was used as the substrate.

### Example 3

An MXene-water dispersion (MXene slurry) was prepared in the same manner as in Example 1.

### [Preparation of Liquid Composition]

The MXene slurry, pure water, and a polyurethane (“RESAMINE D-4080” manufactured by Dainichiseika Color & Chemicals Mfg. Co., Ltd., polyether/polycarbonate-based polyurethane) were blended so that the proportion of MXene (Ti₃C₂Tₓ) in the solid content (component excluding pure water) was 50 vol %, and the blend was shaken and stirred for 15 minutes using an automatic shaker (“SK550 1.1” manufactured by Fast & Fluid) to prepare a liquid composition containing MXene particles and a resin material.

### [Preparation of Liquid Dispersion]

The obtained liquid composition was subjected to a dispersion treatment using a wet atomization device (“STAR BURST MINI” manufactured by Sugino Machine Limited) at a pressure set to 200 MPa to obtain a liquid dispersion.

### [Preparation of Structure]

A structure was prepared in the same manner as in Example 1 except that the obtained liquid dispersion was used and a polyimide substrate (“Kapton” (registered trademark) manufactured by DU PONT-TORAY CO., LTD., 100 H 25 μm) was used as the substrate.

### Example 4

An MXene-water dispersion (MXene slurry) was prepared in the same manner as in Example 1.

### [Preparation of Liquid Composition]

The MXene slurry, pure water, and a polyurethane (“RESAMINE D-4080” manufactured by Dainichiseika Color & Chemicals Mfg. Co., Ltd., polyether/polycarbonate-based polyurethane) were blended so that the proportion of MXene (Ti₃C₂Tₓ) in the solid content (component excluding pure water) was 70 vol %, and the blend was shaken and stirred for 15 minutes using an automatic shaker (“SK550 1.1” manufactured by Fast & Fluid) to prepare a liquid composition containing MXene particles and a resin material.

### [Preparation of Liquid Dispersion]

The obtained liquid composition was subjected to a dispersion treatment using a wet atomization device (“STAR BURST MINI” manufactured by Sugino Machine Limited) at a pressure set to 200 MPa to obtain a liquid dispersion.

### [Preparation of Structure]

A structure was prepared in the same manner as in Example 3 except that the obtained liquid dispersion was used.

### Example 5

A liquid dispersion was prepared in the same manner as in Example 1.

### [Preparation of Structure]

A structure was prepared in the same manner as in Example 1 except that a copper foil having a thickness of 10 μm was used as the substrate.

### Example 6

An MXene-water dispersion (MXene slurry) was prepared in the same manner as in Example 1.

### [Preparation of Liquid Dispersion]

The obtained MXene-water dispersion (MXene slurry) was subjected to a dispersion treatment using a wet atomization device (“STAR BURST MINI” manufactured by Sugino Machine Limited) at a pressure set to 200 MPa to obtain a liquid dispersion containing water and two-dimensional particles.

Next, the obtained liquid dispersion, pure water, and a polyurethane (“RESAMINE D-4080” manufactured by Dainichiseika Color & Chemicals Mfg. Co., Ltd., polyether/polycarbonate-based polyurethane) were blended so that the proportion of MXene (Ti₃C₂Tₓ) in the solid content (component excluding pure water) was 30 vol %, and the blend was shaken and stirred for 15 minutes using an automatic shaker (“SK550 1.1” manufactured by Fast & Fluid) to obtain a liquid dispersion containing the MXene and the polyurethane.

### [Preparation of Structure]

The obtained liquid dispersion was sprayed using a spray coater onto a liquid crystal polymer film having a thickness of 50 μm, which was a 5 cm square substrate whose surface was cleaned with oxygen plasma in advance, to form a precursor film, and then the precursor film was dried with hot air. The spraying and the drying were each repeated 30 times in total.

### (Conditions of Spray Coating)

Atomization pressure: 0.5 MPa
Distance between nozzle tip and substrate: 15 cm
Liquid feeding amount: 5 mL/s
Sweep speed: 150 mm/s
Stage heater: 45° C.

Then, the precursor film was dried at 80° C. for 2 hours in a normal pressure oven and further dried at 150° C. for 15 hours in a vacuum oven to form a film, and thus a structure was obtained.

### Example 7

An MXene-water dispersion (MXene slurry) was prepared in the same manner as in Example 1.

### [Preparation of Liquid Dispersion]

The obtained MXene-water dispersion (MXene slurry) was subjected to a dispersion treatment using a rotation ultrasonic nano disperser (“Nano Premixer PR-1” manufactured by THINKY CORPORATION) to obtain a liquid dispersion containing water and two-dimensional particles.

Next, the obtained liquid dispersion, pure water, and a polyurethane (“RESAMINE D-4080” manufactured by Dainichiseika Color & Chemicals Mfg. Co., Ltd., polyether/polycarbonate-based polyurethane) were blended so that the proportion of MXene (Ti₃C₂Tₓ) in the solid content (component excluding pure water) was 30 vol %, and the blend was shaken and stirred for 15 minutes using an automatic shaker (“SK550 1.1” manufactured by Fast & Fluid) to obtain a liquid dispersion containing the MXene and the polyurethane.

### [Preparation of Structure]

A structure was obtained in the same manner as in Example 6 except that the obtained liquid dispersion was used.

### Example 8

A liquid composition was prepared in the same manner as in Example 1.

### [Preparation of Liquid Dispersion]

The obtained liquid composition was subjected to a dispersion treatment using a thin-film spin system high-speed mixer (“FILMIX” (registered trademark) manufactured by PRIMIX Corporation, 56-L type) to obtain a liquid dispersion.

### [Preparation of Structure]

A structure was prepared in the same manner as in Example 1 except that the obtained liquid dispersion was used.

### Example 9

An MXene-water dispersion (MXene slurry) was prepared in the same manner as in Example 1.

### [Preparation of Liquid Composition]

The MXene slurry, pure water, and an anionic acrylic polymer (“ARON” (registered trademark) NW-400 manufactured by Toagosei Co., Ltd.) were blended so that the proportion of MXene (Ti₃C₂Tₓ) in the solid content (component excluding pure water) was 30 vol %, and the blend was shaken and stirred for 15 minutes using an automatic shaker (“SK550 1.1” manufactured by Fast & Fluid) to prepare a liquid composition containing MXene particles and a resin material.

### [Preparation of Liquid Dispersion]

The obtained liquid composition was subjected to a dispersion treatment using a wet atomization device (“STAR BURST MINI” manufactured by Sugino Machine Limited) at a pressure set to 200 MPa to obtain a liquid dispersion.

### [Preparation of Structure]

A structure was prepared in the same manner as in Example 1 except that the obtained liquid dispersion was used.

### Example 10

A liquid dispersion 1 was prepared in the same manner as in Example 1. Separately, a liquid dispersion 4 was prepared in the same manner as in Example 4.

### [Preparation of Structure]

The obtained liquid dispersion 1 was sprayed using a spray coater onto a liquid crystal polymer film having a thickness of 50 μm, which was a 5 cm square substrate whose surface was cleaned with oxygen plasma in advance, to form a precursor film, and then the precursor film was dried with hot air. The spraying and the drying were each repeated 5 times in total to form a precursor film 1.

### (Conditions of Spray Coating)

Atomization pressure: 0.5 MPa
Distance between nozzle tip and substrate: 15 cm
Liquid feeding amount: 5 mL/s
Sweep speed: 150 mm/s
Stage heater: 45° C.

Then, the precursor film 1 was dried at 80° C. for 2 hours in a normal pressure oven and further dried at 150° C. for 15 hours in a vacuum oven to form a film 1, and thus a structure 1 was obtained.

Next, the obtained liquid dispersion 4 was sprayed using a spray coater onto the surface on which the film 1 was formed of the structure 1 to form a precursor film, and then the precursor film was dried with hot air. The spraying and the drying were each repeated 30 times in total to form a precursor film 2.

### (Conditions of Spray Coating)

Atomization pressure: 0.5 MPa
Distance between nozzle tip and substrate: 15 cm
Liquid feeding amount: 5 mL/s
Sweep speed: 150 mm/s
Stage heater: 45° C.

Then, the precursor film 2 was dried at 80° C. for 2 hours in a normal pressure oven and further dried at 150° C. for 15 hours in a vacuum oven to form a film 2, and thus a structure 2 was obtained.

### Comparative Example 1

A liquid composition was obtained in the same manner as in Example 1.

### [Preparation of Structure]

The obtained liquid composition was sprayed using a spray coater onto a liquid crystal polymer film having a thickness of 50 μm, which was a 5 cm square substrate whose surface was cleaned with oxygen plasma in advance, to form a precursor film, and then the precursor film was dried with hot air. The spraying and the drying were each repeated 30 times in total.

(Conditions of Spray Coating)
Atomization pressure: 0.5 MPa
Distance between nozzle tip and substrate: 15 cm
Liquid feeding amount: 5 mL/s
Sweep speed: 150 mm/s
Stage heater: 45° C.

Then, the precursor film was dried at 80° C. for 2 hours in a normal pressure oven and further dried at 150° C. for 15 hours in a vacuum oven, and thus a structure was obtained.

### Comparative Example 2

An MXene-water dispersion (MXene slurry) was prepared in the same manner as in Example 1.

### [Preparation of Liquid Composition]

The MXene slurry, pure water, and a polyurethane (“RESAMINE D-4080” manufactured by Dainichiseika Color & Chemicals Mfg. Co., Ltd., polyether/polycarbonate-based polyurethane) were blended so that the proportion of MXene (Ti₃C₂Tₓ) in the solid content (component excluding pure water) was 50 vol %, and the blend was shaken and stirred for 15 minutes using an automatic shaker (“SK550 1.1” manufactured by Fast & Fluid) to prepare a liquid composition containing MXene particles and a resin material.

### [Preparation of Structure]

A structure was obtained in the same manner as in Comparative Example 1 except that the obtained liquid composition was used.

### (Measurement of Number Average Particle Size of Two-Dimensional Particles)

### Preparation of Diluent

The film prepared in Examples described above was ground using a mortar and a pestle, the obtained powder body and water were mixed to adjust the proportion of the two-dimensional particles to 0.005 mass % or more in the total of the powder body and the water, the resulting mixture was stirred for 12 hours or more to prepare an aqueous dispersion, and the aqueous dispersion was shaken and stirred for 15 minutes using an automatic shaker (“SK550 1.1” manufactured by FAST & Fluid) to obtain a diluent.

### (Scanning Electron Microscope (SEM) Observation of Two-Dimensional Particles)

### Preparation of Observation Sample

One drop of the obtained diluent was added dropwise with a dropper onto a silicon substrate whose surface was cleaned with oxygen plasma, and dried overnight to prepare an observation sample.

### SEM Observation

The observation sample was observed using a scanning electron microscope (S-4800 manufactured by Hitachi High-Technologies Corporation). The magnification was set to 10,000 times. The obtained scanning electron microscope image was binarized using image analysis software (“ImageJ” manufactured by National Institutes of Health). Furthermore, the maximum Feret diameter was measured for 50 or more particles using the image analysis software, and the number average was calculated to determine the number average particle size.

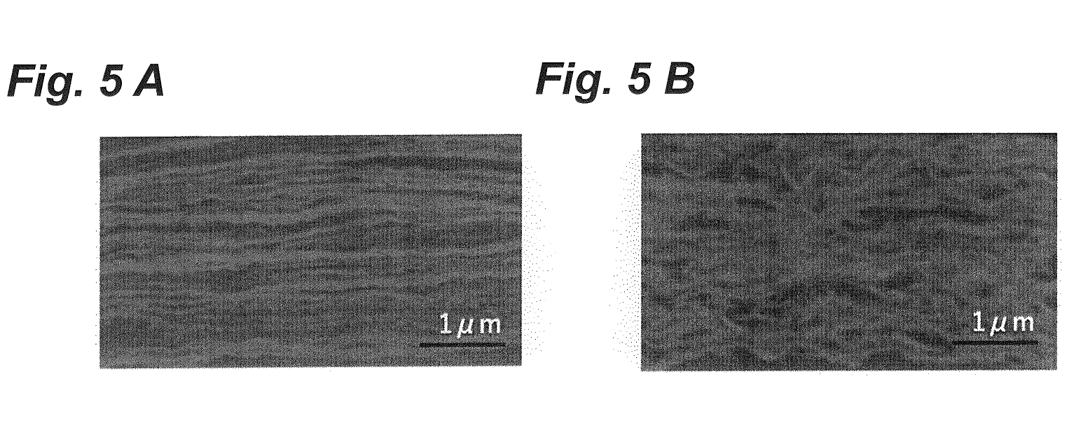

Separately, the sections of the films of the structures obtained in Comparative Example 1 and Example 1 were similarly observed with a scanning electron microscope. FIG. 5A shows the observation result of Comparative Example 1, and FIG. 5B shows the observation result of Example 1. A region with high brightness indicates an existing region of the two-dimensional particles, and a region with low brightness indicates an existing region of the polymer.

(Measurement of D50 (Based on Volume) of Mixture of Two-Dimensional Particles and Polymer with Laser Diffraction Method)

### Preparation of Diluent for Measurement of Particle Size Distribution

The film obtained in Examples and Comparative Examples described above was ground using a mortar and a pestle, the obtained powder body and water were mixed to adjust the proportion of the two-dimensional particles to 1 wt % or less in the total of the powder body and the water, the resulting mixture was stirred for 12 hours or more to prepare an aqueous dispersion, and the aqueous dispersion was shaken and stirred for 15 minutes using an automatic shaker (“SK550 1.1” manufactured by FAST & Fluid) to obtain a diluent for measurement of particle size distribution.

Evaluation with Laser Diffraction/Scattering Particle Size Distribution Measuring Device (LA960)

Measurement was performed while the prepared diluent for measurement of particle size distribution was added dropwise to ion-exchanged water circulating in a laser diffraction/scattering particle size distribution measuring device (LA960 manufactured by HORIBA, Ltd.) with adjusting the amount of the added diluent so that the obtained transmittance was, in principle, 70% to 99%.

### Data Analysis

The particle size distribution was measured using a complex refractive index of the two-dimensional particles of 1.690-0.900i, and D50 in terms of volume was calculated.

### (Surface Analysis by X-Ray Photoelectron Spectroscopy)

The film surfaces of the structures prepared in Examples 1 to 9 and Comparative Examples 1 and 2, and the surfaces of the films 1 and 2 of the structures prepared in Example 10 were measured by X-ray photoelectron spectroscopy (XPS) using PHI Quantes manufactured by ULVAC-PHI, Inc.

The elemental composition (atom %) was calculated from the semiquantitative analysis in the narrow scan analysis, and the (C+N)/Ti ratio was determined.

### (Bending Test)

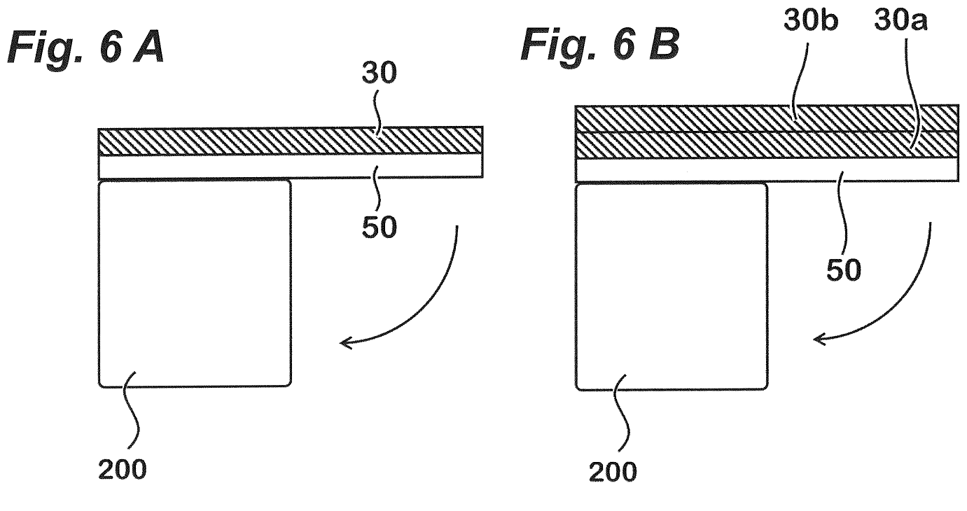

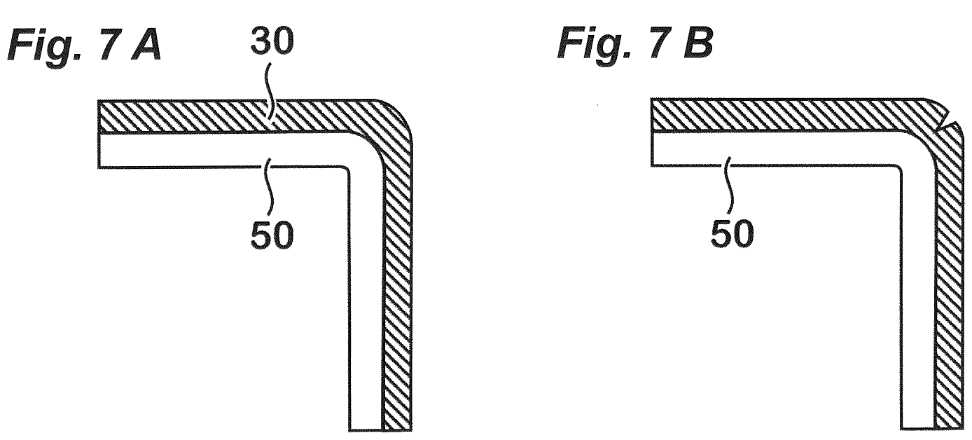

As shown in FIG. 6A, in Examples 1 to 9 and Comparative Examples 1 and 2, a laminate including the substrate 50 and the film 30 prepared was cut into a strip shape of 0.5 cm×5 cm, the strip was applied to a metal rectangular parallelepiped 200 having a corner having a radius R=1.2 mm so that the substrate 50 was in contact with a plane of the metal rectangular parallelepiped 200, and the structure was bent at 90 degrees along the corner having a radius R=1.2 mm. Furthermore, as shown in FIG. 6B, in Example 10, a laminate including the substrate 50, the film 1 30a, and the film 2 30b prepared was cut into a strip shape of 0.5 cm×5 cm, the strip was applied to a metal rectangular parallelepiped 200 having a corner having a radius R=1.2 mm so that the substrate 50 was in contact with a plane of the metal rectangular parallelepiped 200, and the structure was bent at 90 degrees along the corner having a radius R=1.2 mm. The film 30 and the film 2 30b after bending were evaluated in the bending test with a visually discriminating method. The evaluation results were obtained in accordance with the following criteria.
o: No crack is observed in the film or on the surfaces of the films 1 and 2 (FIG. 7A).
x: A crack is observed in the film or on the surface of the film 2, or the film is broken (FIG. 7B).

Table 1 shows the results.

TABLE 1

| | | | | | Number | | |
|---|---|---|---|---|---|---|---|
| | | | | | average | | (C + N)/ |
| | | | | | particle | | Ti |
| | | MXene | Polymer | | size | D50 | Element |
| Example | | Vol % | Kind | Vol % | (μm) | (μm) | ratio |
| Example 1 | | 30 | Polyurethane | 70 | 0.08 | 1.1 | 14.3 |
| Example 2 | | 30 | Polyurethane | 70 | 0.08 | 1.1 | 14.3 |
| Example 3 | | 50 | Polyurethane | 50 | 0.1 | 0.9 | 11 |
| Example 4 | | 70 | Polyurethane | 30 | 0.12 | 0.8 | 8.1 |
| Example 5 | | 30 | Polyurethane | 70 | 0.12 | 1.1 | 14.3 |
| Example 6 | | 30 | Polyurethane | 70 | 0.09 | 1.2 | 15.6 |
| Example 7 | | 30 | Polyurethane | 70 | 0.15 | 1.1 | 14.3 |
| Example 8 | | 30 | Polyurethane | 70 | 3.1 | 10 | 18 |
| Example 9 | | 30 | Acryl | 70 | 0.2 | 1.1 | 14.2 |
| Example | Film 1 | 30 | Polyurethane | 70 | 0.08 | 1.1 | 14.3 |
| 10 | Film 2 | 70 | Polyurethane | 30 | 0.12 | 0.8 | 8.1 |

| | | | | | | |
|---|---|---|---|---|---|---|
| Comparative | 30 | Polyurethane | 70 | 4.6 | 22.3 | 26.2 |
| Comparative | 50 | Polyurethane | 50 | 4.6 | 18.2 | 20.1 |

| | | | | Substrate | | |
|---|---|---|---|---|---|---|
| | | Dispersion method | | | Thickness | |
| | | MXene | | | | |
| Example | | slurry | Liquid composition | Kind | (μm) | Bending |
| Example 1 | | None | Wet atomization | Liquid crystal | 50 | ○ |
| | | | device | polymer film | | |
| Example 2 | | None | Wet atomization | PET | 25 | ○ |
| | | | device | | | |
| Example 3 | | None | Wet atomization | Polyimide | 25 | ○ |
| | | | device | | | |
| Example 4 | | None | Wet atomization | Polyimide | 25 | ○ |
| | | | device | | | |
| Example 5 | | None | Wet atomization | Copper foil | 10 | ○ |
| | | | device | | | |
| Example 6 | | Wet | None | Liquid crystal | 50 | ○ |
| | | atomization | | polymer film | | |
| | | device | | | | |
| Example 7 | | Rotation | None | Liquid crystal | 50 | ○ |
| | | ultrasonic | | polymer film | | |
| | | nano | | | | |
| | | disperser | | | | |
| Example 8 | | None | Thin-film spin | Liquid crystal | 50 | ○ |
| | | | system high-speed | polymer film | | |
| | | | mixer | | | |
| Example 9 | | None | Wet atomization | Liquid crystal | 50 | ○ |
| | | | device | polymer film | | |
| Example | Film | None | Wet atomization | Liquid crystal | 50 | ○ |
| 10 | 1 | | device | | | |
| | Film | None | Wet atomization | polymer film | | |
| | 2 | | | | | |

| | | | | | |
|---|---|---|---|---|---|
| Comparative | None | None | Polyimide | 25 | x |
| Comparative | None | None | Polyimide | 25 | x |

In Examples 1 to 10, the number average particle size of the two-dimensional particles is 4.0 μm or less, and is smaller than the number average particle size of the two-dimensional particles of Comparative Examples 1 and 2. In Examples 1 to 10, the D50 of the two-dimensional particles measured with a laser diffraction method is 10.0 μm or less. In Examples 1 to 10, it is considered that the two-dimensional particles and the polymer are well mixed in the liquid dispersion used for formation of the film. Also in a case where the film surface is evaluated by X-ray photoelectron spectroscopy (XPS), the proportion of the total of carbon atoms and nitrogen atoms to 100 atom % of Ti atoms ((C+N)/Ti) is 18.0 atom % or less, and is smaller than that in Comparative Examples. From this, it is considered that in the structures of Examples 1 to 10, two-dimensional particles exist up to the surface of the film and thus MXene is dispersed in the polymer not only on the surface of the film but also inside the film. In Examples 1 to 10, it has been confirmed that a structure excellent in bending resistance and/or stretch resistance is obtained without breakage of the film in the bending test.

In particular in Example 10, a film having a large proportion of the polymer is used as the film 1 30a in contact with the substrate 50, and a film having a large proportion of the two-dimensional particles is used as the film 2 30b disposed on the film 1. Therefore, the adhesion of the film to the substrate 50 can be improved, and at the same time, the conductivity can be also improved.

Meanwhile, in Comparative Examples 1 and 2, the number average particle size of the two-dimensional particles is more than 4.0 μm, and is out of the scope of the present disclosure. The D50 of the two-dimensional particles measured with a laser diffraction method is also large, and existence of an aggregate is considered in the liquid composition used for formation of the film. Also in the XPS evaluation of the film surface, the proportion of the total of carbon atoms and nitrogen atoms to 100 atom % of Ti atoms ((C+N)/Ti) is 20.1 atom % or more. From this, in the structures of Comparative Examples 1 and 2, it is considered that a large amount of the polymer exists on the surface of the film and the structures have a part in which the two-dimensional particles are aggregated inside the film. In Comparative Examples 1 and 2, breakage of the film was confirmed in the bending test. It is considered that fracture occurred from the MXene aggregation part having low strength to break the film.

### REFERENCE SIGNS LIST

1a, 1b Layer body (MₘXₙ layer)
3a, 5a, 3b, 5b Modifier or terminal T
7a, 7b MXene layer
10, 10a, 10b Two-dimensional particles (particles of layered material)
20 Polymer
30, 30A Film
30a Film 1
30b Film 2
50, 50A Substrate
51A Upper surface
52A Lower surface
100, 100A Structure
200 Metal rectangular parallelepiped

What is claimed is:

1. A structure comprising:
one or more substrates having flexibility; and
one or more films in contact with at least a part of a surface of the one or more substrates,
wherein the one or more films contain two-dimensional particles including one or plural layers, and the one or more films contain a polymer,
wherein the one or plural layers include:
a layer body represented by:
MₘXₙ
wherein M is at least one metal of Group 3, 4, 5, 6, or 7,
X is a carbon atom, a nitrogen atom, or a combination of a carbon atom and a nitrogen atom,
n is 1 to 4, and
m is more than n and 5 or less; and
a modifier or terminal T exists on a surface of the layer body, wherein T is at least one selected from a hydroxyl group, a fluorine atom, a chlorine atom, an oxygen atom, and a hydrogen atom,
wherein a proportion of the two-dimensional particles in the one or more films is 5 to 75 vol % based on 100 vol % of a total of the two-dimensional particles and the polymer, and
wherein the two-dimensional particles have a number average particle size of 0.001 μm to 0.8 μm.

2. The structure according to claim 1, wherein the number average particle size of the two-dimensional particles is 0.001 μm to 0.5 μm.

3. The structure according to claim 1, wherein a D50 determined by measuring a mixture of the two-dimensional particles and the polymer with a laser diffraction method is 0.001 μm to 15 μm.

4. The structure according to claim 1, wherein a D50 determined by measuring a mixture of the two-dimensional particles and the polymer with a laser diffraction method is 0.001 μm to 10 μm.

5. The structure according to claim 1, wherein a D50 determined by measuring a mixture of the two-dimensional particles and the polymer with a laser diffraction method is 0.001 μm to 5 μm.

6. The structure according to claim 1, wherein an average of the thicknesses of the two-dimensional particles is 1 to 15 nm.

7. The structure according to claim 1, wherein
the MₘXₙ is M3X2-, and
a total proportion of carbon atoms and nitrogen atoms on a surface of the one or more films measured by X-ray photoelectron spectroscopy is 0.67 atom % to 25 atom % with respect to 100 atom % of atoms of M on the surface of the one or more films.

8. The structure according to claim 1, wherein the polymer contains a polymer material having:
at least one selected from a fluorine atom, a chlorine atom, an oxygen atom, and a nitrogen atom, as a hydrogen acceptor; and
a hydroxyl group and/or a secondary amino group as a hydrogen donor.

9. The structure according to claim 1, wherein the polymer contains a polymer material having a urethane bond.

10. The structure according to claim 1, wherein the polymer contains an anionic resin material excluding polyvinyl alcohol, the anionic resin material containing an anionic polymer, the anionic polymer having at least one of a carboxylic acid group or a carboxylate group and having no NH group.

11. The structure according to claim 1, wherein the polymer contains an acrylic resin.

12. The structure according to claim 1, wherein the proportion of the two-dimensional particles in the one or more films is 45 to 70 vol %.

13. The structure according to claim 1, wherein the proportion of the two-dimensional particles in the one or more films is 5 to 70 vol %.

14. The structure according to claim 1, wherein the proportion of the two-dimensional particles in the one or more films is 5 to 40 vol %.

15. The structure according to claim 1, wherein the polymer contains at least one of:
a polymer material having a hydrogen bonding group, and
an anionic polymer having at least one of a carboxylic acid group or a carboxylate group and having no NH group.

16. The structure according to claim 15, wherein the polymer contains both of the polymer material and the anionic polymer.

17. The structure according to claim 15, wherein a total content of the polymer material and the anionic polymer in 100 mass % of the polymer is 70 to 100 mass %.
